(19) United States
(12) Patent Application Publication
(10) Pub. No.: US 2006/0004974 A1
(43) Pub. Date: Jan. 5, 2006

(54) Portable non-volatile memory device and method for preventing unauthorized access to data stored thereon

(76) Inventors: Paul Lin, Fremont, CA (US); Fu-Hua Lee, Foster City, CA (US)

Correspondence Address: Jeffrey P. Aiello, 4911 Pony Pass Circle, San Jose, CA, 95136, US

(21) Appl. No.: 11/223,540

(22) Filed: Sep. 9, 2005

Related U.S. Application Data
(63) Continuation-in-part of application No. 10/387,883, filed on Mar. 13, 2003.

(51) Int. Cl. G06F 12/14

(52) U.S. Cl. 711/164

(57) ABSTRACT

A portable non-volatile memory device and method for preventing unauthorized access to data stored on the memory device is provided. The invented memory device and method prevents unauthorized access to data stored on the device without requiring self-installing software to protect the data stored on the device. Data and information stored on the device may be accessed or manipulated quickly. Coupling the invented device to the computer activates the device. Upon activation, a window is generated on a computer screen. A Graphical User Interface requests authentication information for accessing data stored on the device. If the correct authentication information is input, then access to the data stored on the invented device is granted, otherwise access to the data is denied. Once access is granted, data stored on the device may be displayed in the window and can be transferred between the device and a host computer.

### CROSS-REFERENCE TO RELATED APPLICATIONS

This Application is a continuation-in-part of U.S. patent application Ser. No. 10/387,883, filed on Mar. 13, 2003.

### BACKGROUND OF THE INVENTION

1. Field of the Invention

The present invention relates to portable non-volatile memory devices, and more particularly, to a portable non-volatile memory device and method for preventing unauthorized access to data stored on the memory device.

2. Background Information

Portable memory can be found in a number of today's portable electronic devices. Portable memory is commonly found in such portable electronic devices such as Notebook computers, Personal Digital Assistants (PDA's), cellular telephones, and digital cameras, to name a few. Often the portable memory device used in these applications may comprise a solid-state memory device, such as a Flash memory card or memory stick.

An emerging flash memory device is a Flash memory drive. Flash memory drives, or flash drives, are somewhat compact, typically measuring approximately 2.5 inches long and 0.5 inches wide, and can function in a manner similar to that of a conventional hard disk drive. Some flash drives can hold up to eight Gigabytes of data, and are used to store a multiplicity of data files. Flash drives are also capable of storing large data files such as image files and music files.

Flash drives are typically provided with a known connector to couple the drive to a host device. For example, flash drives are commonly provided with a known Universal Serial Bus (USB) connector for coupling the drive to a USB port of a computer. Once connected to the USB port, a user may upload files from the flash drive to the computer or download files from the computer to the drive.

One such flash drive is sold under the trademark “Attache”, by PNY Technologies, Inc., Parsippany, N.J. As disclosed by PNY Technologies, Inc., on their website (www.pny.com), the Attache flash drive may be configured with up to approximately 2 GB of data storage and configured with a USB connector for coupling the drive to PC and MAC operating system computers.

Due to the diminutive dimensions and portability of flash drives, a disadvantage thereof is that they can be easily lost or misplaced by a user. A further disadvantage is that, if the flash drive is lost or misappropriated, a party other than the user may connect the flash drive to a computer they control and gain unauthorized access to data and information stored on the flash drive. As can be imagined, some data stored on the flash drive may be considered confidential.

A flash drive that attempts to inhibit unauthorized access to data stored thereon, is sold under the trademark “JumpDrive Secure”, by Lexar Media, Inc., Fremont, Calif., and can been viewed on their website (www.lexar.com). As disclosed therein, the JumpDrive Secure flash drive is provided with software that enables a user to password-protect data stored on the flash drive. The JumpDrive Secure flash drive may be configured with a data storage capacity of up to 1 GB and provided with a USB connector for connecting the drive to the user's computer.

In use, the JumpDrive Secure flash drive is coupled to a USB port of a computer. Once the flash drive is connected, an auto-run or executable program stored on the flash drive is invoked. The executable program uploads software stored on the JumpDrive Secure to the host computer and installs the software on the computer.

During installation, the software partitions the memory of the JumpDrive Secure in to a “Private” sector and a “Public” sector. Anyone possessing the JumpDrive Secure may view data and information stored in the Public sector of the JumpDrive Secure's memory and may transfer data between the Public sector and the host computer.

If a user of the JumpDrive Secure flash drive desires to access data and information stored in the Private sector of the drive's memory, the user is prompted to input a password. If the user inputs the correct password, then access to data and information stored the Private sector is granted. If the incorrect password is entered, then access to the Private sector is denied.

However a disadvantage of this type of flash drive is that it must self-install the software stored thereon to function. This can be a time consuming process and inconvenient for a user. Further, due to increased security and computer virus concerns, computer users are often suspicious of programs that self-install and devices that include self-installing software.

A further disadvantage of this type of flash drive is that anyone possessing the flash drive has access to data stored in the Public sector. Thus, if confidential data is inadvertently stored in the public sector, it can be accessed and manipulated by an unintended user of the drive.

Thus, a portable non-volatile memory device and method that prevents unauthorized access to data stored on the device, without requiring self-installing software to protect the data stored on the device would be advantageous over the prior art.

### BRIEF SUMMARY OF THE INVENTION

The present invention provides a portable non-volatile memory device and method for preventing unauthorized access to data stored on the device. The invented device and method prevents unauthorized access to data stored on the device, without requiring self-installing software to protect the data stored on the device. Thus, data and information stored on the device is protected, yet it may be accessed or manipulated relatively quickly.

In use, the invented portable memory device is coupled to a host device, such as a user's computer. Coupling the invented device to the computer activates the device. Upon activation, a window on a screen of the user's computer is generated.

In the window, the system files of the memory device may first be displayed. Next, a Graphical User Interface (GUI) may be generated on the computer screen. The GUI may request that authentication information be input for accessing data stored on the invented device. The authentication information may comprise confidential information such as a Username, Password, Personal Identification Number (PIN), or a combination thereof, for example. If the correct authentication information is input in the GUI, then access to the data stored on the invented device is granted. If the correct authentication information is not input in the GUI, then access to the data stored on the invented device is denied.

Once access to the data stored on the invented device is granted, files stored on the device may be displayed in the window, as is well known in the art. Data may be transferred between the device and a host computer and data stored on the device may be manipulated as desired.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, in which:

FIG. 1 is a schematic diagram of an embodiment of a portable non-volatile memory device of the present invention coupled to a computer; and

FIG. 2 is a flow chart showing a preferred embodiment of the method of the present invention.

### DESCRIPTION OF THE PREFERRED EMBODIMENTS

The following description is provided to enable any person skilled in the art to make and use the invention and sets forth the best modes presently contemplated by the inventors of carrying out the invention. Various modifications, however, will remain readily apparent to those skilled in the art, since the generic principles of the present invention have been defined herein.

The present invention provides a portable non-volatile memory device and method for preventing unauthorized access to data stored on the device. The invented device and method prevents unauthorized access to data stored on the device, without requiring self-installing software to protect the data stored on the device. Thus, data and information stored on the device is protected, yet it may be accessed or manipulated relatively quickly.

Once access to the data stored on the invented device is granted, files stored on the device may be displayed in the window, as is well known in the art. Data may be transferred between the device and a host computer and data stored on the device may be manipulated as desired.

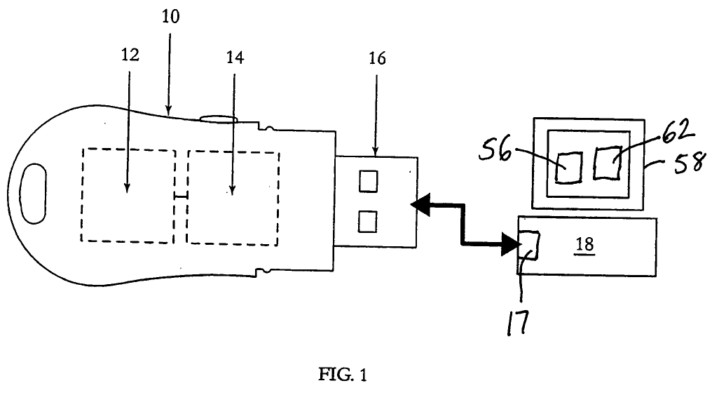

Referring now to FIG. 1 of the drawings, a preferred embodiment of a portable non-volatile memory device of the present invention is shown generally at 10. The invented portable memory device 10 may be provided in any suitable form factor. In a preferred embodiment shown, invented device 10 is configured as a personal token device.

The invented device 10 may include an on-board processor 12 for processing data and a nonvolatile memory 14 for storing data. The token's memory 14 may comprise a known solid-state memory device that maintains data when power to the device 10 is removed. Preferably, the memory 14 comprises known flash memory.

The invented device 10 also includes a coupling portion 16 for coupling the device 10 to a data port 17 of a computer 18. The coupling portion 16 may be configured in a form factor compatible with coupling the device 10 to a data port 17. For example, coupling portion 16 may comprise a known USB (Universal Serial Bus) connector for coupling the device 10 to a USB port of the computer 18.

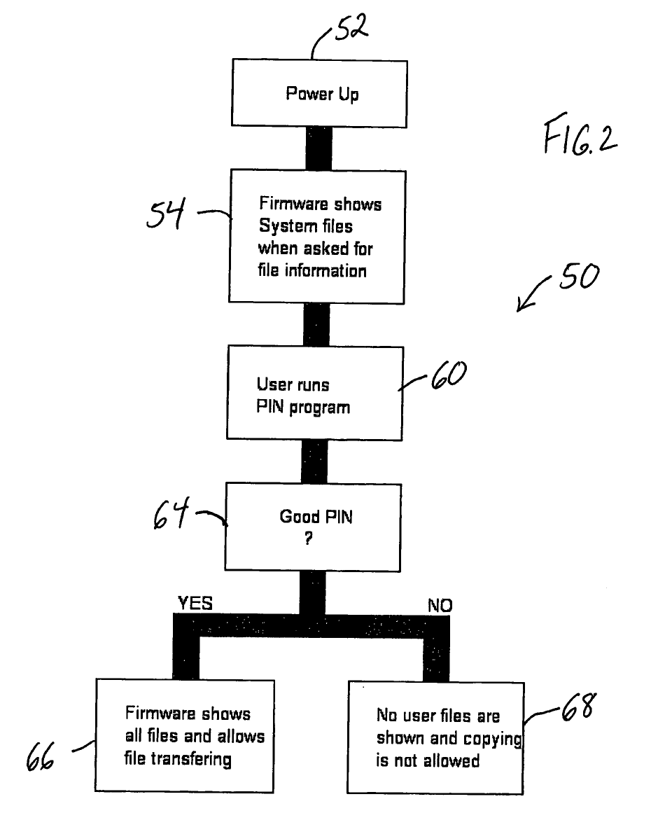

Referring now to FIG. 2 of the drawings, there is shown generally at 50, a flow chart illustrating a preferred method of the present invention. Referring to FIG. 1 and FIG. 2, the invented device 10 is coupled to a host device, such as the computer 18. Upon coupling the device 10 to the computer 18, the device is activated as shown in process block 52. As shown in process block 54, upon activation, a window 56 is generated on a screen 58 of the computer 18.

In the window 56, the system files of the device 10 may be displayed. As shown in process block 60, a user then requests access to data stored on the invented device 10.

Upon this request, a Graphical User Interface (GUI) 62 may be generated on the computer screen 58. The GUI 62 requests that authentication information be input for accessing data stored on the invented device 10. The authentication information may comprise confidential information such as a Username, Password, Personal Identification Number (PIN), or a combination thereof, for example.

In process block 64 it is determined if the correct authentication information was input in the GUI 62. If the correct authentication information was input, then, as shown in process block 66, access to the data stored on the invented device 10 is granted. If the correct authentication information is not input in the GUI 62, then access to the data stored on the invented device 10 is denied, as shown in process block 68.

Once access to the data stored on the invented device 10 is granted, files stored on the device 10 may be displayed in the window 56, as is well known in the art. Data may be transferred between the device 10 and the computer 18 and data stored on the device 10 may be manipulated as desired.

Thus, there has been disclosed a portable non-volatile memory device and method for preventing unauthorized access to data stored on the memory device is provided. The invented memory device and method prevents unauthorized access to data stored on the device without requiring self-installing software to protect the data stored on the device. Data and information stored on the device is protected, yet may be accessed or manipulated quickly.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

What is claimed is:

1. A method for preventing unauthorized access to data stored on a memory device, the method comprising the following steps:
(a) coupling the memory device to a host device;
(b) generating a graphical user interface;
(c) requesting authentication information;
(d) inputting authentication information;
(e) determining if the authentication information is correct; and
(f) if the authentication information is correct, then granting access to data stored on the memory device, and if the authentication information is not correct then denying access to the data on the memory device.

2. The method of claim 1 wherein the authentication information comprises one of a username, a password, and a personal identification number.

3. The method of claim 1 wherein the memory device comprises a portable memory device.

4. The method of claim 3 wherein the portable memory device contains solid-state memory for storing data.

5. The method of claim 1 wherein the host device comprises a computer that includes a display.

6. A method for preventing unauthorized access to data stored on a portable memory device without requiring self-installing software to protect the data stored on the device, the method comprising the following steps:
(a) coupling the portable memory device to a host device to activate the memory device;
(b) displaying information on the host device
(c) generating a graphical user interface requesting authentication information from the host device;
(d) inputting authentication information;
(e) determining if the authentication information is correct; and
(f) if the authentication information is correct, then granting access to data stored on the memory device and displaying the data on the host device, and if the authentication information is not correct then denying access to the data on the memory device,
whereby unauthorized access to data stored on the memory device is prevented without uploading self-installing software to the host device.

7. The method of claim 6 wherein the authentication information comprises at least one of a username, a password, and a personal identification number.

8. The method of claim 6 wherein the portable memory device contains solid-state memory for storing data.

9. The method of claim 6 wherein the host device comprises a computer that includes a display device.

10. The method of claim 9 further comprising:
generating a window on the display device of the computer.

11. The method of claim 9 wherein the graphical user interface is displayed on the display device of the computer.

12. The method of claim 10 wherein the information displayed on the display device of the computer includes systems files stored on the portable memory device and displayed in the window generated on the display device of the computer.

13. The method of claim 10 wherein upon granting access to data stored on the memory device the data is displayed in the window generated on the display device of the computer.

14. A portable memory device configured to prevent unauthorized access to data stored thereon comprising:
a housing containing a processor for processing data and a memory for storing data; and
an interface for coupling the memory device to a host device, the processor coupled to the interface for sensing if the memory device is coupled to a host device, if the memory device is coupled to a host device, then the processor runs a program that displays information on the host device, the program generating a graphical user interface requesting authentication information from the host device, if the authentication information from the host device matches authentication information stored in memory, then access to data stored in memory is granted, and if the authentication information from the host device does not match authentication information stored in memory, then access to data stored in memory is denied.

15. The device of claim 14 wherein the authentication information comprises at least one of a username, a password, and a personal identification number.

16. The device of claim 14 wherein the portable memory device contains solid-state memory for storing data.

17. The device of claim 14 wherein the host device comprises a computer that includes a display device, the graphical user interface is displayed on the display device of the computer.

18. The method of claim 17 wherein upon granting access to data stored on the memory device the data is displayed in a window generated on the display device of the computer.
